(19) United States
(12) Patent Application Publication
(10) Pub. No.: US 2017/0074641 A1
(43) Pub. Date: Mar. 16, 2017

(54) TRANSLATING NATURAL MOTION TO A COMMAND

(71) Applicants: Michael Dean Tschirhart, Ann Arbor, MI (US); Anthony Joseph Ciatti, Ann Arbor, MI (US); Alexander Albanese, Oak Park, MI (US)

(72) Inventors: Michael Dean Tschirhart, Ann Arbor, MI (US); Anthony Joseph Ciatti, Ann Arbor, MI (US); Alexander Albanese, Oak Park, MI (US)

(21) Appl. No.: 14/853,435

(22) Filed: Sep. 14, 2015

(51) Int. Cl. G01B 11/00; G06F 3/01; G06F 1/16; G06F 3/00

(52) U.S. Cl. CPC G01B 11/002; G06F 3/005; G06F 3/017; G06F 1/163

(57) ABSTRACT

Systems and methods for translating natural motion into a command are provided herein. The system includes a natural motion receiver configured to receive an indication of natural motion; a digital information retriever configured to retrieve digital information associated with the natural motion; and a digital information communicator configured to communicate the retrieved digital information to an electronic system. The natural motion is defined by a motion associated with an interaction independent of the electronic system. Also included is a method for integrating a natural motion detector with an electrical system. Also included is a description wearable technology device associated with the concepts discussed herein.

### BACKGROUND

Electronics, electronic system, and the like are being incorporated in numerous locations, contexts, and environments. For example, in the vehicular context, the electronic system may facilitate interaction or engagement with the vehicle. Various vehicle systems may be controlled via a singular or multiple electrical systems, such as a climate control system, driving system, entertainment system, and the like.

Traditionally, interfaces were implemented in an analog fashion. Thus, settings would be controlled via mechanical knobs and switches. Indications would be indicated via mechanical pointers and the like.

In recent times, the analog displays have been replaced with digital displays. Especially in the vehicular context, digital displays have replaced or augmented existing analog displays. Instrument clusters are now being incorporated with digital displays, such as light-emitting diode technologies and the like. The digital displays are coupled with the electronic system, and are configured to digitally render information based on inputs and outputs entered into the electronic system.

In the vehicle, multiple displays may be implemented. For example, a digital display may be embedded in the cockpit or the information system. In another example, a heads-up display (HUD) may be implemented on the front windshield or other transparent or translucent surfaces.

The electronic systems are commonly incorporated with processing technologies, such as processors, field programmable gate arrays (FPGA)s, application-specific integrated circuits (ASIC)s, electronic control units (ECU)s, and the like. The electronic systems are provided with various interface technologies, such as keyboards, mouse technologies, touch screen displays, and the like.

In recent times, more interfaces have been realized that are non-contact based. For example, a gaze tracking device may be implemented. The gaze tracking device is incorporated in a manner that tracks a user's gaze, direction of gaze, blinking and the like. The tracked information is then employed to control an electronic system.

Other non-contact interface devices also exist and are being implemented, such as, but not limited to, a remote control, a gesture-based input device, a head tracking device, and the like. As these control technologies are known, and thus, a detailed explanation will be omitted.

Another emerging technology is wearable tech. Wearable tech is defined as electronic devices worn on a user's body, such as wrist watches, finger clips, clipped on electronic devices and the like. The wearable tech is capable of detecting movement of the user, and communicating said movement to a third-party electronic device (often times a user's smart phone).

With all these electronic systems and displays being incorporated in a vehicle, a user's distraction is increased. The distraction may lead to a more engaging experience, but simultaneously, a dangerous experience.

### SUMMARY

The following description relates to system and methods for translating natural motion into a command. Exemplary embodiments may also be directed to any of the system, the method, an application provided on a personal device associated with the aspects disclosed herein.

Additional features of the invention will be set forth in the description which follows, and in part will be apparent from the description, or may be learned by practice of the invention.

Systems and methods for translating natural motion into digitally rendered information are provided herein. The system includes a natural motion receiver configured to receive an indication of natural motion; a digital information retriever configured to retrieve digital information associated with the natural motion; and a digital information communicator configured to communicate the retrieved digital information to an electronic system. The natural motion is defined by a motion associated with an interaction independent of the electronic system. Also included is a method for integrating a natural motion detector with an electrical system. Also included is a description wearable technology device associated with the concepts discussed herein.

It is to be understood that both the foregoing general description and the following detailed description are exemplary and explanatory and are intended to provide further explanation of the invention as claimed. Other features and aspects will be apparent from the following detailed description, the drawings, and the claims.

### DESCRIPTION OF THE DRAWINGS

The detailed description refers to the following drawings, in which like numerals refer to like items, and in which:

FIG. 1 is a block diagram illustrating an example computer.

FIG. 2 illustrates an example of a system for translating natural motion into a command.

FIG. 3 illustrates an example of a method for translation of a natural motion into a command or action associated with an electronic system.

FIG. 4 illustrates an example of a method for integrating natural motion detection and an electronic system.

FIGS. 5(a)-(c) illustrate an example of an implementation of the system shown in FIG. 2.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

As explained in the Background section, electronic systems, such as digital displays and wearable tech, are being implemented in numerous locations and contexts. One such location and context is a vehicle.

Safety and providing a safe manner of operating the electronic systems and the wearable tech are of great paramount, especially in the context of driving a vehicle. If the driver's eyes are averted from the road while operating the electronic system and the wearable tech, the driver may be distracted from various roadside conditions and signs that would obstruct or inform the driver of danger and other driving conditions.

Many actions by a driver are based on natural motions associated with analog and non-digital based technology. One such example is observing a wrist watch. The driver may turn their hand and view the wrist watch to obtain information about the date and time.

As wrist watches become “smart”, and are capable of conveying more information, such as information commonly displayed via a smart phone or tablet, the driver may complete this action in a more frequent manner.

Disclosed herein are methods, systems, and devices for translating natural motion into a command. Natural motion is any sort of motion made by a user, driver, engager of an electrical system that reflects a motion made with a non-digital device. As explained above, the viewing of time on a wrist via a wrist watch device may correspond to a natural motion.

The digitally rendered information is rendered on a display, such an information system or a HUD. Thus, because the information is displayed in a singular display already being employed by the user, driver, or engager—the user, driver, or engager may avoid averting their eyes from a specific focus.

The aspects disclosed herein describe an example with a vehicle. The vehicle represents one implementation of the concepts described below. In another example, the concepts described below may be employed with an electronic system, display, and wearable tech implemented in a non-vehicular context.

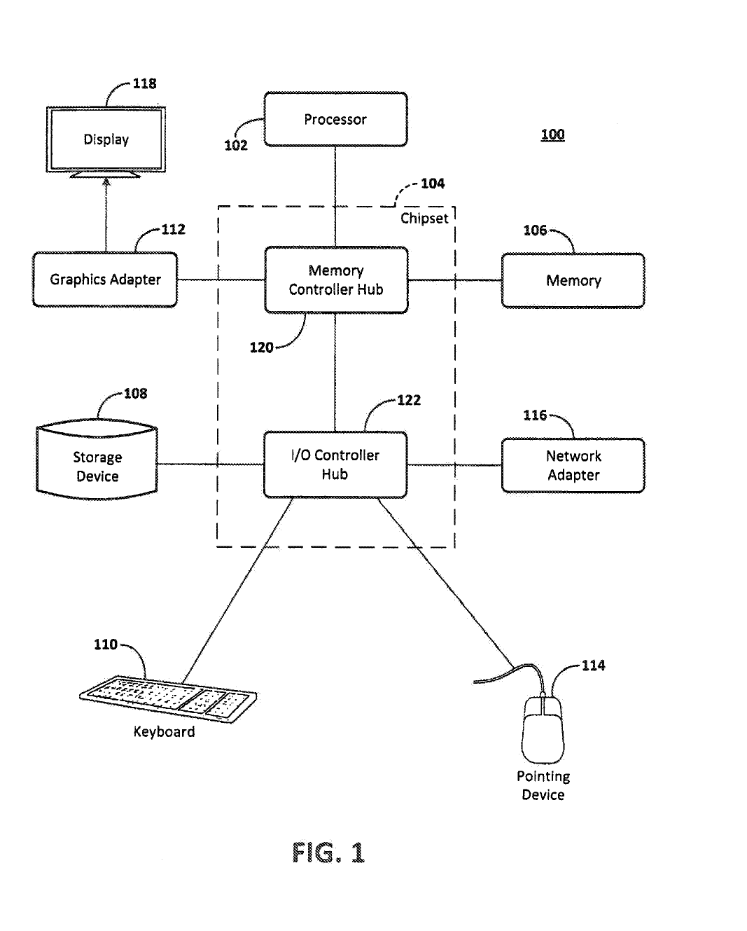

FIG. 1 is a block diagram illustrating an example computer 100. The computer 100 includes at least one processor 102 coupled to a chipset 104. The chipset 104 includes a memory controller hub 120 and an input/output (I/O) controller hub 122. A memory 106 and a graphics adapter 112 are coupled to the memory controller hub 120, and a display 118 is coupled to the graphics adapter 112. A storage device 108, keyboard 110, pointing device 114, and network adapter 116 are coupled to the I/O controller hub 122. Other embodiments of the computer 100 may have different architectures.

The storage device 108 is a non-transitory computer-readable storage medium such as a hard drive, compact disk read-only memory (CD-ROM), DVD, or a solid-state memory device. The memory 106 holds instructions and data used by the processor 102. The pointing device 114 is a mouse, track ball, or other type of pointing device, and is used in combination with the keyboard 110 to input data into the computer 100. The pointing device 114 may also be a gaming system controller, or any type of device used to control the gaming system. For example, the pointing device 114 may be connected to a video or image capturing device that employs biometric scanning to detect a specific user. The specific user may employ motion or gestures to command the point device 114 to control various aspects of the computer 100.

The graphics adapter 112 displays images and other information on the display 118. The network adapter 116 couples the computer system 100 to one or more computer networks.

The computer 100 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 108, loaded into the memory 106, and executed by the processor 102.

The types of computers used by the entities and processes disclosed herein can vary depending upon the embodiment and the processing power required by the entity. The computer 100 may be a mobile device, tablet, smartphone or any sort of computing element with the above-listed elements. For example, a data storage device, such as a hard disk, solid state memory or storage device, might be stored in a distributed database system comprising multiple blade servers working together to provide the functionality described herein. The computers can lack some of the components described above, such as keyboards 110, graphics adapters 112, and displays 118.

The computer 100 may act as a server (not shown) for the content sharing service disclosed herein. The computer 100 may be clustered with other computer 100 devices to create the server. The various computer 100 devices that constitute the server may communicate with each other over a network.

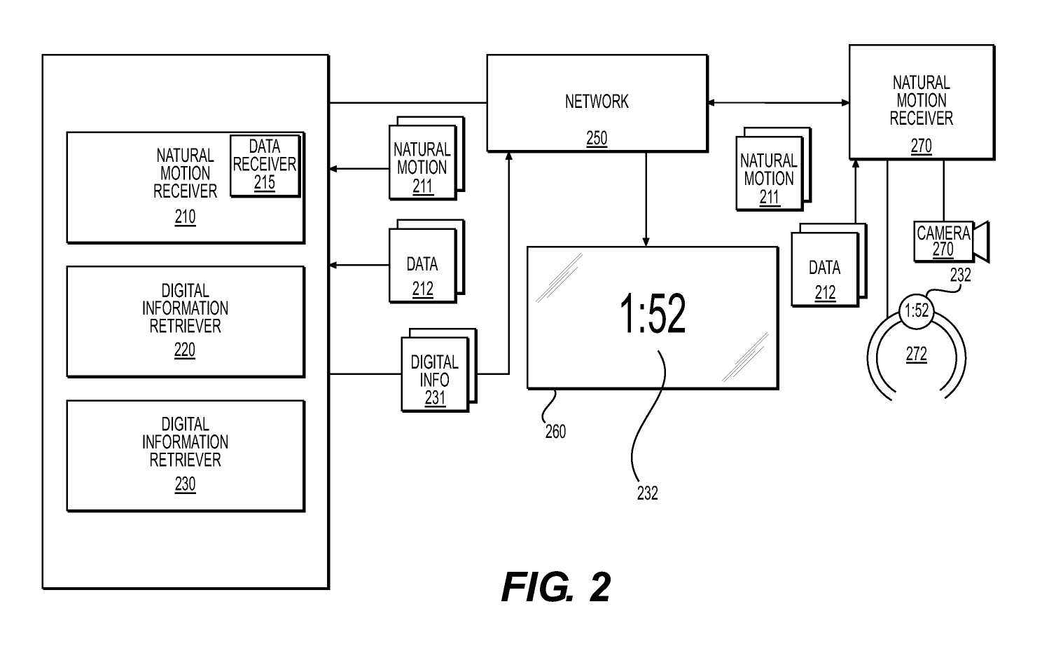

FIG. 2 illustrates an example system 200 for translating natural motion into digital information. In certain cases, the digitally rendered information may be presented on an electronic display 260. The system 200 is implemented on a computing device, such as computer 100. The system 200 includes a natural motion receiver 210, a digital information retriever 220, and a digital information communicator 230.

The system 200 may be embedded in an electronic control unit (ECU) or network 250. The ECU/network 250 facilitates communication from the various peripheral devices associated with the implementation of system 200.

Coupled to the system 200, via the ECU/network 250 is a display 260. The display 260 may be any sort of digital display capable of displaying digital information. Various information, text, media, and the like are rendered onto the digital display 260. The ECU/network 250 is configured to transmit digital information that is render-able onto the display 260.

Also shown is a natural motion receiver 270. The natural motion receiver 270 may be any sort of detection device capable of detecting movement of a user in a non-contact manner with either the ECU/network 250 or the display 260. The natural motion receiver 270 is coupled to the network 250 via known wired or wireless techniques.

The natural motion receiver 270, in FIG. 2, is shown with two different implementations. One such implementation is a camera 271 (or any image/video capturing device). The camera 271 captures movement of an appendage, the captured video or images undergo digital signal processing (DSP), and are translated to a defined movement or displacement data (natural movement data 211). The natural movement data 211 is communicated to the system 200, via network 250.

In another example, the natural movement data 211 is generated by a wearable tech device 272 (shown as a wrist band in FIG. 2). The wearable tech device 272 may be any sort of device capable of detecting motion or movement. As shown in FIG. 2, the wearable tech device 272 is capable of interfacing with the ECU/network 250 in a networked fashion, and after the interface communicating, 1) the natural movement data 211; and 2) data associated with a display 212 (as shown in FIG. 2, the current time 232; however, with smart watches and the like, this data may reflect the screen associated with the smart watch).

The natural motion shown/detected in FIG. 2 is coupled with a turn of the wrist. However, as explained below, other natural motions may be detected (via a wearable tech device, or other type of detection technique).

The natural motion receiver 210 is configured to receive the natural movement data 211. From the natural movement data 211, the natural motion receiver 210 may obtain information about movement or displacement of an appendage associated with an engager of the display 260.

In another example, the natural motion receiver 210 may include a data receiver 215. The data receiver 215 is configured to receive associated data with a wearable tech device 272 associated with the engager and producer of the natural movement data 211. As shown in FIG. 2, the data 212 is received by system 200, and reflects the current time 232 associated with the wearable tech device 272. The current time 232 may be communicated to system 200, via ECU/network 250, via data 212.

The digital information retriever 220 is configured to retrieve corresponding information to display based on the received data by the natural motion receiver 210. The digital information retriever 220 may cross-reference a database or lookup table, and correspond the specific motion with a specific command.

The digital information communicator 230 is configured to communicate the retrieved digital information 231 retrieved by element 220 to the display 260. The digital information 231 may be in a form capable of being rendered by the display 260, or need to be translated via an intermediary processing operation.

In another example, the communicator 230 may cause the display 260 to switch a presentation of a currently displayed item to another display (not shown). For example, if the system 200 is instructed to display the current time 232, the contents presently on display 260 may be switched over temporarily to another display situated in the context or environment where system 200 is implemented in.

As shown in FIG. 2, display 260 is showing the time 232 of ‘1:52’. This information corresponds to the information shown on the wearable tech 272.

In the case shown, the information is transmitted and shown on display 260. In another example (not shown), the system 200 may be configured to open a two-way communication between the display 260 and the wearable tech device 272, and thus, allow data 212 to be directly communicated from the wearable tech device 272 to the display 260.

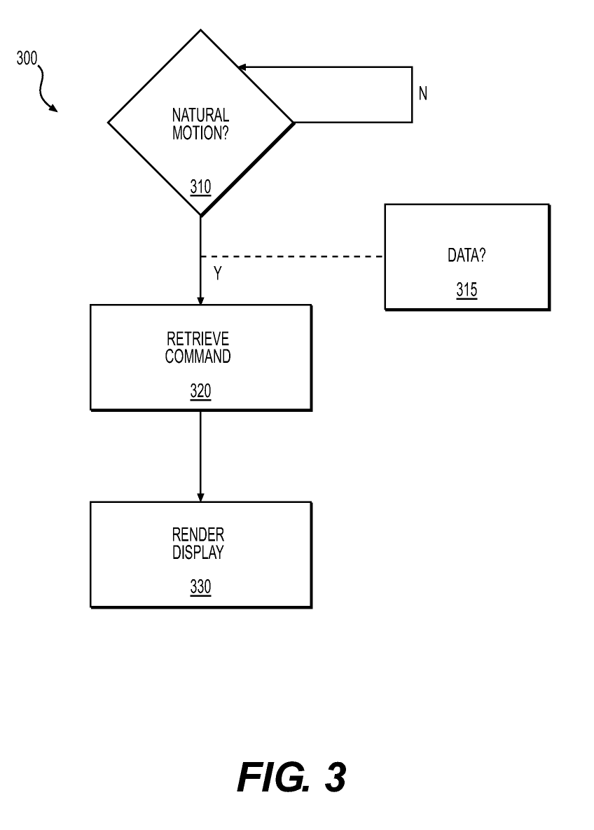

FIG. 3 illustrates a method 300 for translation of a natural motion into a command or action associated with an electronic system. The method 300 may be embedded into various hardware componentry in communication with the sensor technologies described above, such as the natural motion receiver 270.

In operation 310, a determination is made as to whether a natural motion is received. If no, the method 300 keeps polling operation 310. If yes, the method 300 proceeds to operation 320.

In operation 320, a retrieving of a command associated with the detected natural motion occurs (for example, via operation 315, through a retrieval of data). The command corresponds digital action or display items to be rendered onto a digital display not affixed or associated with a device capturing the natural motion. For example, in the vehicular context, the display may be a HUD or information display, while the device capturing the command may be a wearable tech device.

In operation 330, the command retrieved in operation 320 is rendered onto the digital display. Thus, the natural motion (i.e. flicking/turning a wrist to check time from a wrist watch), causes the display to render information. For example, if the user associated with method 300 is wearing a smart watch, the display of the smart watch would be coupled to the display associated with the vehicle.

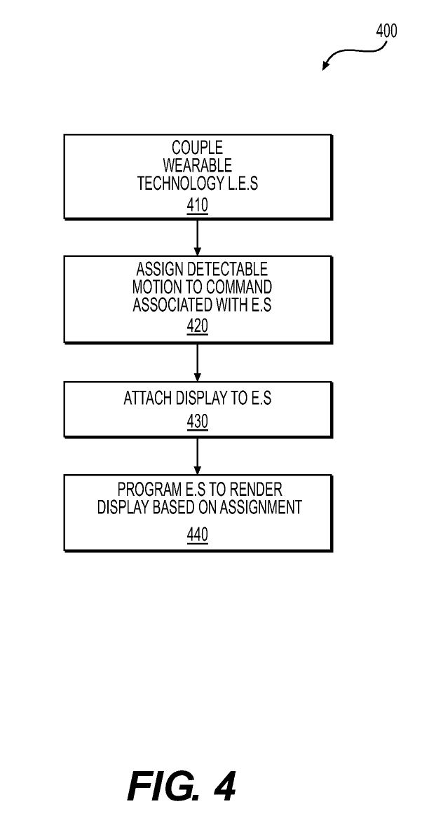

FIG. 4 illustrates an example of a method 400 for integrating natural motion detection and an electronic system. The method 400 shown may be employed and provided along with the system 200 shown above.

In operation 410, a coupling between a wearable technology device and an electronic system occurs. The coupling may be performed by providing a wireless interface capable of handshaking and sharing data with the wearable technology.

In another implementation of operation 410, a wearable technology device may be omitted. A detection of a motion associated with a natural motion (for example, checking one's wrist to determine the time) may substitute the usage of wearable technology. As explained above, this implementation may be performed via a camera or motion tracking device provided in a system where an electronic system is implemented.

In operation 420, detectable natural motions (i.e. turning a wrist) are assigned to controllable inputs for an electronic system. The assignments may be stored in a lookup table or database, with each natural motion being corresponded to a specific input action or device.

In operation 430, a display may be coupled to the electronic system. The display may render an indication based on the detected natural motion. In another example of method 400, the display may generically be any output or system capable of instigating an action based on a received command.

In operation 440, the electronic system is programmed to render or produce an output based on the assignment in operation 420. Thus, based on the aspects disclosed with method 400, an implementation of integrating a detected natural motion with a command may be achieved.

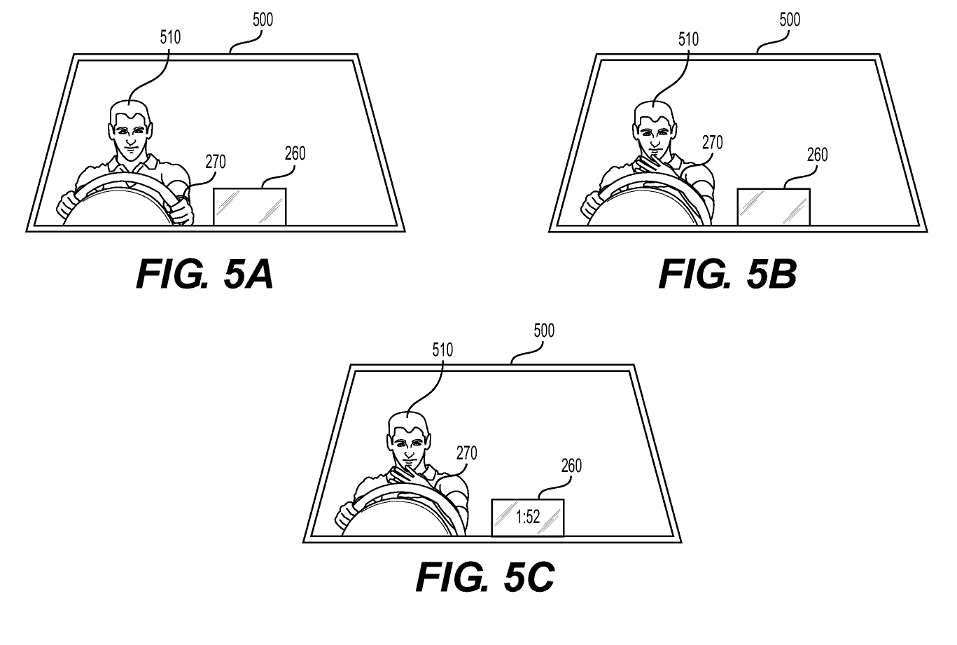

FIGS. 5(a)-(c) illustrate an example of an implementation of the system shown in FIG. 2. As shown, the implementation is depicted in a vehicle 500. However, implementers of system 200 may employ the aspects in other contexts or environments.

Referring to FIGS. 5(a)-(c), a vehicle 500 includes a driver 510 wearing a wearable tech device 272. Also included is a display 260 (which may be any of the displays enumerated above). System 200 is also included in the example (not shown). The system 200 is configured to couple to a detection device that detects a natural motion.

As shown in FIG. 5(b), the natural motion of flicking a wrist is made. The system 200 detects this motion and causes the display 260 to render the present time (as shown in FIG. 5(c)).

There are numerous examples of natural motions that may be specifically implemented with the aspects disclosed herein. In another example, certain gestures may be employed that are commonly associated with a specific meaning. A driver or passenger may point a finger, indicating a desire to “wrap things up”. Employing the aspects disclosed herein, that may be translated into a specific command. For example, system 200 may detect the natural motion (i.e. through a wearable device or other detection technique), and translate said detected natural motion into a command, for example, an automatic loading of a GPS instruction guiding the driver or passenger to return to a predetermined location (i.e. a home).

In another example, the natural motion may be a “thumbs up” gesture. The “thumbs up” gesture may be correlated with a command indicating going backwards or to a previous location/command/setting. Alternatively, the “thumbs up”/“thumbs down” may be correlated to a favorable/dis-favorable indication (for example, in the selection of a radio station).

Another example natural motion may be a flat palm to the forehead. The flat palm to the forehead may indicate a scanning of the horizon. The flat palm may be translated to a zoom function. I.e., if a GPS map is illustrated via a vehicular display, the scanning of the horizon may lead to a zoomed-in function of the area being gestured at which the flat palm motion.

A computer program (also known as a program, module, engine, software, software application, script, or code) can be written in any form of programming language, including compiled or interpreted languages, declarative or procedural languages, and the program can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

To provide for interaction with an individual, the herein disclosed embodiments can be implemented using an interactive display, such as a graphical user interface (GUI). Such GUI's may include interactive features such as pop-up or pull-down menus or lists, selection tabs, scannable features, and other features that can receive human inputs.

The computing system disclosed herein can include clients and servers. A client and server are generally remote from each other and typically interact through a communications network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

We claim:

1. A system for translating natural motion into digitally rendered information, comprising:
a data store comprising a computer readable medium storing a program of instructions for the translating of natural motion;
a processor that executes the program of instructions;
a natural motion receiver configured to receive an indication of natural motion;
a digital information retriever configured to retrieve digital information associated with the natural motion; and
a digital information communicator configured to communicate the retrieved digital information to an electronic system,
wherein the natural motion is defined by a motion associated with an interaction independent of the electronic system.

2. The system according to claim 1, wherein the natural motion is a turning of a wrist associated with a user of the electronic system.

3. The system according to claim 2, wherein in response to the turning of the wrist, a digital display coupled to the electronic system renders the time.

4. The system according to claim 1, wherein the natural motion is detected from a wearable device.

5. The system according to claim 2, wherein the natural motion is detected from a wearable device.

6. The system according to claim 1, wherein the natural motion is detected by an image capturing device.

7. The system according to claim 2, wherein the natural motion is detected by an image capturing device.

8. The system according to claim 2, wherein in response to the turning of the wrist, the digital information retriever is configured to receive data displayed on the wearable device, and replicate the received data onto a digital display.

9. The system according to claim 2, wherein in response to the turning of the wrist, the system is configured to establish a handshake connection between a display associated with the wearable device and a display coupled to the electronic system.

10. A wearable technology device coupled to an electronic system, comprising:
a motion detector configured to detect a natural motion; and
a wireless communication circuit configured to wirelessly couple to the electronic system,
wherein in response to detecting the natural motion, the electronic system translates the detected natural motion into a command.

11. The device according to claim 10, wherein the wearable technology device is wrist-wearable.

12. The device according to claim 11, wherein the natural motion is associated with turning a wrist.

13. The device according to claim 12, wherein the command is indicating a time on a display coupled to the electronic system.

14. A method for integrating natural motion detection and an electronic system, comprising:
coupling a natural motion detector with the electronic system;
assigning at least one natural motion detectable via the natural motion detector to a command for controlling the electronic system; and
programming the electronic system to render an output based on the detected natural motion.

15. The method according to claim 12, wherein the natural motion detection is accomplished by a wearable technology device.

16. The method according to claim 14, wherein the natural motion detector is a camera configured to detect motion.

17. The method according to claim 14, wherein the rendered output is information displayed on a display coupled to the electronic system.

18. The system according to claim 1, wherein the natural motion is defined by detecting a motion associated with an index finger.

19. The system according to claim 1, wherein the natural motion is defined by detecting a thumb up/down gesture.

20. The system according to claim 1, wherein the natural motion is defined by detecting a placement of a flat palm on a forehead.
